(19) United States
(12) Patent Application Publication
(10) Pub. No.: US 2003/0226829 A1
(43) Pub. Date: Dec. 11, 2003

(54) Resistance element and method for trimming the same

(76) Inventors: Mitsuru Aoki, Nukata-gun (JP); Takaharu Futamura, Anjo-city (JP)

Correspondence Address: POSZ & BETHARDS, PLC, 11250 ROGER BACON DRIVE, SUITE 10, RESTON, VA, 20190, US

(21) Appl. No.: 10/453,935

(22) Filed: Jun. 4, 2003

(30) Foreign Application Priority Data
Jun. 5, 2002 (JP) 2002-164397

(51) Int. Cl. B23K 26/00

(52) U.S. Cl. 219/121.67; 219/121.6

(57) ABSTRACT

First slits are alternately cut from opposing sides of a resistance element by a serpentine-cut laser trimming. Each slit is perpendicular to the longitudinal axis of the resistance element. The slits are cut for roughly adjusting a resistance of the resistance element. Second slits are cut between and in parallel to the first slits. The slits are cut for fine adjusting the resistance of the resistance element. A range of the fine-adjustment for a variation in the resistance is estimated by changing a distance between the first slits and the second slits.

### CROSS REFERENCE TO RELATED APPLICATION

This application is based on and incorporates herein by reference Japanese Patent Application No. 2002-164397 filed on Jun. 5, 2002.

### FIELD OF THE INVENTION

The present invention relates to a resistance element and a method for trimming the resistance element.

### BACKGROUND OF THE INVENTION

A resistance element made of a metal thin film and formed on a semiconductor substrate is trimmed by a laser trimming to adjust its resistance. One method for trimming a resistance element is disclosed in JP-A-8-159899, Trimming patterns of the element are shown in FIG. 4. In this method, a rough trimming is performed in a rough-adjustment area 100a and a fine trimming is performed in a fine-adjustment area 100b after the rough trimming.

In the rough-adjustment area 100a, a serpentine-cut trimming is performed. Rough-trimming slits 110 are formed during the serpentine-cut trimming. By this trimming, the resistance element 100 virtually becomes long and thin. Therefore, the resistance of the element 100 increases. Fine trimming slits 120 are formed in the fine-adjustment area 100b, in which variation in resistance is small. The fine-adjustment area 100b is located away from the rough-adjustment area 100a and an edge of the element 100. The second slits 120 are indicated by dashed lines.

The resistance is fine adjusted by changing lengths LC, Lc′ or numbers of the fine-adjustment slits 120. In the fine adjustment of the resistance, a certain distances A is required between the fine-adjustment slits 120 and a closer edge 100c of the resistance element 100. Likewise, a certain distance B is required between the fine-adjustment slits 120 and the closest rough-adjustment slit 110. To meet the requirement, the element 100 requires a large total area.

Furthermore, variations in resistance become larger as the lengths Lc, Lc′ become longer even when variations in length are small. A current path is indicated by solid-line arrows when the fine-adjustment slit 120 has a length of Lc and by dashed-line arrows when the fine-adjustment slit 120 has a length of LC′. As shown in the figure, the current path greatly changes depending on the length of the fine-adjustment slit 120. As a result, the resistance may largely changes. This makes it difficult to perform the fine adjustment difficult with high accuracy and to estimate a range of the fine adjustment.

### SUMMARY OF THE INVENTION

The present invention therefore has an objective to provide a trimming method for adjusting a resistance of a resistance element, in which a fine adjustment is performed in a small trimming area while a variation in resistance is properly controlled. In this method, first slits are alternately cut from opposing sides of a resistance element such that each slit is perpendicular to the longitudinal axis of the resistance element. Second slits are cut between each first slit such that each slit is perpendicular to the longitudinal axis of the resistance element.

The first slits are cut for roughly adjusting the resistance of the resistance element. The second slits are cut for fine adjusting the resistance. The second slits are located in a rough-adjustment area in which the first slits are located. As a result, the area required for the trimming is reduced.

### BRIEF DESCRIPTION OF THE DRAWINGS

The above and other objectives, features and advantages of the present invention will become more apparent from the following detailed description made with reference to the accompanying drawings. In the drawings:

FIG. 1 is a plane view of a resistance element according to an embodiment of the present invention;

FIG. 2 is a schematic view of the resistance element showing slits and current paths;

FIG. 3 is a chart showing relationships of a variation in distance between the first slits and the second slits with a variation in resistance; and

FIG. 4 is a plane view of trimming patterns on a resistance element according to the related art;

### DETAILED DESCRIPTION OF THE PREFERRED EMBODIMENT

The preferred embodiments of the present invention will be explained with reference to the accompanying drawings. In the drawings, the same numerals are used for the same components and devices.

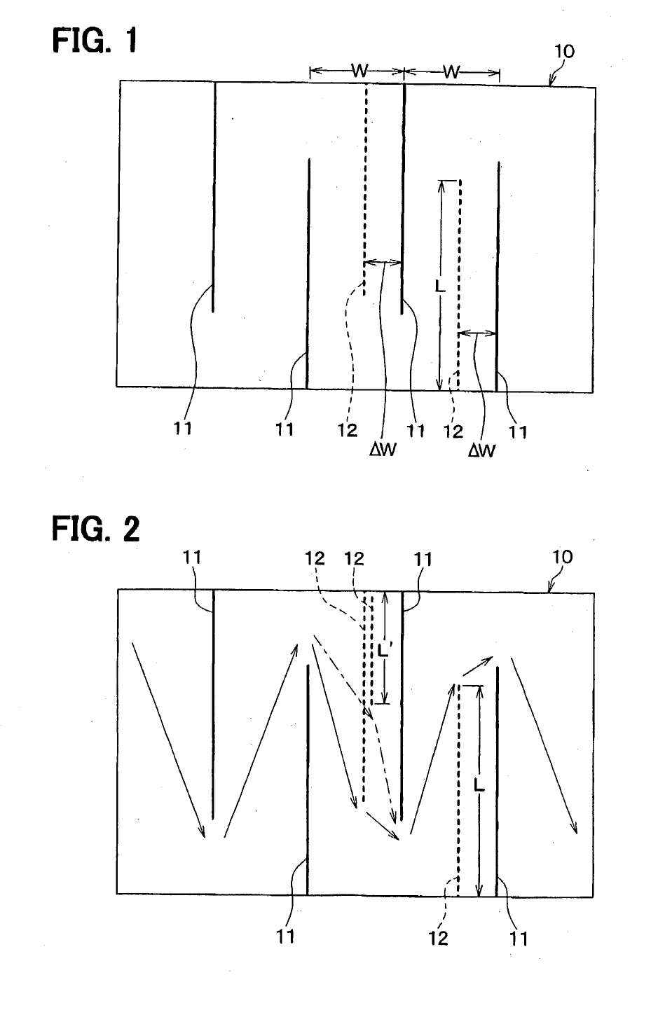

A resistance element 10 is made of a metal thin film, including a Cr—Si thin film, and formed on a semiconductor substrate, such as a silicon substrate. Referring to FIG. 1, first slits 11 are alternately cut from opposing sides of the resistance element 10 at intervals of W by a laser trimming. The first slits 11 are the first slits to cut for roughly adjusting resistance of the resistance element 10. Each slit 11 is perpendicular to the longitudinal axis of the resistance element 10. It passes beyond the longitudinal center line of the resistance element 10.

Second slits 12 are cut in the same manner as the first slits 11 but they are arranged between the slits 11 a distance of ΔW away from the closest first slit 11. The second slits 12 are the second slits to cut for fine adjusting resistance of the resistance element 10 that is roughly adjusted. The second slits 12 have a length of L.

A method for manufacturing the resistance element 10 will be explained. The resistance element 10 is formed on a semiconductor substrate, such as a silicon substrate, using a patterning technique. The patterning technique uses vapor or sputter deposition and photo lithography. The resistance of the resistance element 10 is adjusted to a target value by trimming. A YAG laser trimming is used for trimming the resistance element 10. Electrodes on both ends of the resistance element 10 are connected to a measuring instrument to monitor the resistance. While the resistance is monitored, the resistance element 10 is heated and vaporized by a laser beam. The laser beam is applied so that it travels in the direction parallel to the shorter side of the resistance element 10. When the resistance under monitoring becomes the target value, the application of the laser beam is stopped.

A serpentine-cut laser trimming is performed to the resistance element 10 to cut several first slits from opposing sides of the resistance element 10. The resistance of the resistance element 10 is roughly adjusted by the serpentine-cut laser trimming. Then, another laser trimming is performed to cut the second slits between the first slits. By this trimming, the resistance is fine adjusted. When this trimming is completed, the resistance element 10 is finished.

The resistance is roughly adjusted by forming the first slits 11, and fine adjusted by forming the second slits 12 between the slits 11. In other words, both first slits 11 and second slits 12 are formed in the same area. Therefore, the area required for the trimming can be reduced.

A current path in the resistance element 10 changes depending on the length of the second slits 12 as shown in FIG. 2 when the second slits 12 has a length of L, the current flows as indicated by solid-line arrows. When the second slits 12 has a length of L′, which is shorter than L, the current flows as indicated by dashed-line arrows. Since the second slits 12 are located between the first slits 11, the current path does not greatly change based on the length of the second slits 12.

Moreover, the resistance can be adjusted in a proper range by changing the distance ΔW between the first slits 11 and the second slits 12. The resistance is increased by narrowing a width of the resistance element 10 to W and ever more increased by narrowing to W-ΔW in the rough adjustment area. In other words, the resistance is fine adjusted in the second step of narrowing the width of the resistance element 10.

More specifically, it a sheet resistance of the resistance element 10 is S, a distance between the first slits 11 and the second slits 12 is ΔW, a length of the second slits 12 is L, a length between the first slits 11 is W, and a variation in the resistance by the fine adjustment ΔR, the variation ΔR is calculated by the following equation.

$$\begin{matrix}Δ R = S \cdot \{ L / W - L / ( W - Δ W ) \} \\ = S \cdot L \cdot \{ 1 / W - 1 / ( W - Δ W ) \}\end{matrix}$$

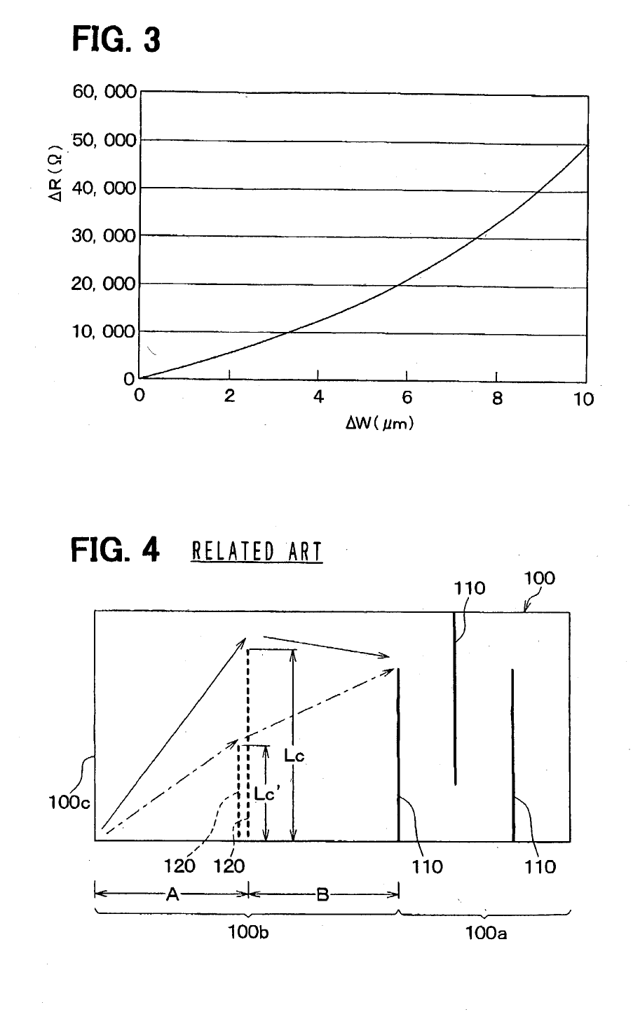

The variation AR is approximately proportional to the length L of the second slits 12. However, the variation .R can be estimated by changing the distance ΔW. A relationship between the distance ΔW and the variation ΔR when W=20 μm, L=200 μm, and S=500 Ω/sq is shown in FIG. 3. The variation ΔR can be properly estimated by changing the distance ΔW.

Since small changes can be made in the resistance by changing the distance ΔW, the accuracy of the fine adjustment improves in combination with changing the lengths of the second slits 12. Furthermore, the area required for the trimming is reduced and the fine adjustment is possible under a condition that the variation in the resistance is properly controlled.

The present invention should not be limited to the embodiment previously discussed and shown in the figures, but may be implemented in various ways without departing from the spirit of the invention. For example, the first slits 11 and the second slits 12 may be cut in different lengths.

What is claimed is:

1. A method for trimming a resistance element to adjust resistance thereof comprising:
alternately cutting first slits from opposing sides of the resistance element such that each slit is perpendicular to a longitudinal axis of the resistance element; and
cutting second slits between first slits such that each slit is perpendicular to the longitudinal axis of the resistance element.

2. The method for trimming a resistance element according to claim 1, wherein the first slits overlap each other in such a way that each slit passes beyond the longitudinal centerline of the resistance element.

3. The method for trimming a resistance element according to claim 1, wherein the first slits are cut at regular intervals.

4. The method for trimming a resistance element according to claim 1, wherein a serpentine-cut laser trimming is used to cut the first slits.

5. The method for trimming a resistance element according to claim 1, wherein a laser trimming is used to cut the second slits.

6. The method for trimming a resistance element according to claim 1, wherein the second slits are positioned an appropriate distance away from the first slits so that the resistance of the resistance element is fine adjusted to a target value.

7. A resistance element comprising a metal thin film in a substantially rectangular shape, in which a resistance thereof is adjusted by a trimming, wherein:
the metal thin film has first slits that are alternately cut from opposing sides thereof such that each slit is perpendicular to the longitudinal axis of the metal thin film;
the metal thin film has second slits that are cut between each first slit;
the resistance of the resistance element is roughly adjusted by cutting the first slits; and
the resistance of the resistance element is fine adjusted by cutting the second slits.

8. The resistance element according to claim 7, wherein the first slits are positioned at regular intervals.
